(19) United States
(12) Patent Application Publication
(10) Pub. No.: US 2023/0227142 A1
(43) Pub. Date: Jul. 20, 2023

(54) GIMBALING CYCLIC THRUST VECTORING

(71) Applicant: ZeroAvia, Inc., Hollister, CA (US)

(72) Inventor: Gabriel Valentine DEVAULT-STRONG, Watsonville, CA (US)

(73) Assignee: ZeroAvia, Inc., Hollister, CA (US)

(21) Appl. No.: 18/155,576

(22) Filed: Jan. 17, 2023

Related U.S. Application Data
(60) Provisional application No. 63/300,329, filed on Jan. 18, 2022.

(51) Int. Cl. B64B 1/30

(52) U.S. Cl. CPC B64B 1/30

(57) ABSTRACT

A propulsion system for a lighter-than-air craft including a motor outputting a driving force including one or more rotors. This propulsion system is a free-pivoting, swashplate-controlled system interconnecting the motor and the one or more rotors for lighter-than-air aircraft.

### CROSS-REFERENCE TO RELATED APPLICATIONS (PROVISIONAL)

This application claims priority to and the benefit of co-pending U.S. Provisional Patent Application 63/300,329, filed on Jan. 18, 2022, entitled “GIMBALING CYCLIC THRUST VECTORING”, by Gabriel Devault-Strong, and assigned to the assignee of the present application, the disclosure of which is hereby incorporated herein by reference in its entirety.

### FIELD

The present disclosure relates to propulsion systems and, more particularly, relates to free-pivoting, swashplate-controlled rotors for lighter-than-air aircraft.

### BACKGROUND

This section provides background information related to the present disclosure which is not necessarily prior art. This section provides a general summary of the disclosure, and is not a comprehensive disclosure of its full scope or all of its features.

An airship or dirigible balloon is a type of aerostat or lighter-than-air (LTA) aircraft that can navigate through the air under its own power. Airships gain lift from a lifting gas that is less dense than the surrounding air. Generally, airships comprise an envelope that serves as its structure that contains the buoyant or lifting gas. A gondola is typically coupled to the envelope and at least one of the gondola and the envelope can be fitted with a propulsion system. Often, the propulsion system comprises a plurality of propeller-driven pods that can be independently controlled to provide maneuverability of the airship.

As airships have been increasingly used to carry heavier cargo, their size is becoming larger thereby benefiting from thrust-vectoring propulsion pods. However, in many situations, the associated propellers and/or rotors of these thrust-vectoring propulsion pods are becoming larger and/or are operating at higher speeds. During operation, these larger propellers and/or rotors produce increased moment forces from gyroscopic loads, especially when the propellers and/or rotors are pivoted, thereby leading to destructive and/or undesirable forces being exerted upon the propulsion system and/or associated structure of the airship. In some conventional applications, attempts to overcome these forces have employed counter-rotating propellers.

However, in accordance with the teachings of the present disclosure, a propulsion system is provided having free-pivoting, swashplate-controlled rotors as described and illustrated herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a conventional propulsion system of a lighter-than-air aircraft having a propulsion system, generally described as a servo in pod.

FIG. 2 is a schematic view of a propulsion system according to the principles of the present teachings having free-pivoting, swashplate-controlled rotors.

FIG. 3 is a perspective view of the propulsion system according to the principles of the present teachings according to some embodiments having components labelled.

FIG. 4 is a perspective view of the propulsion system according to the principles of the present teachings according to some embodiments.

FIG. 5 is a side view of the propulsion system according to the principles of the present teachings according to some embodiments.

FIG. 6 is a top view of the propulsion system according to the principles of the present teachings according to some embodiments.

FIG. 7 is a side view of the propulsion system according to the principles of the present teachings according to some embodiments.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

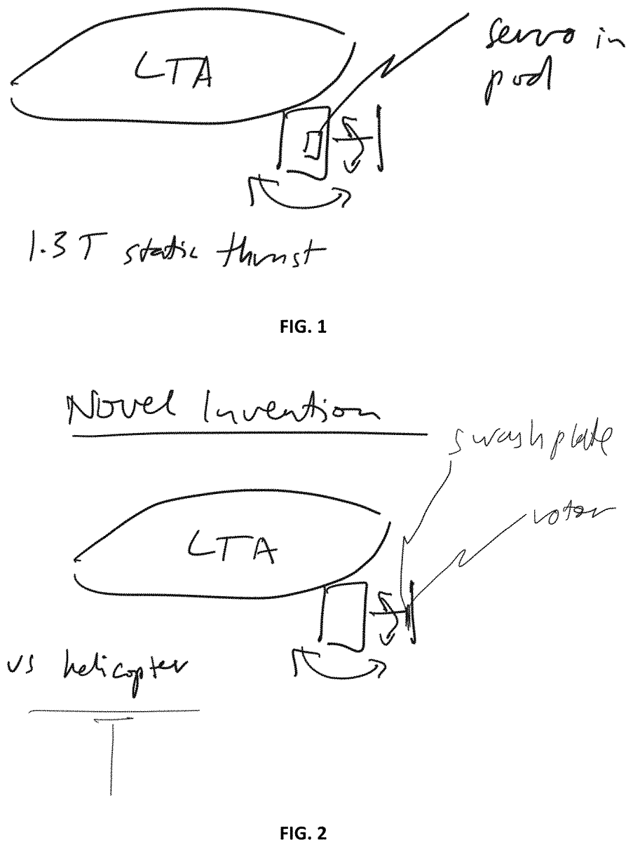

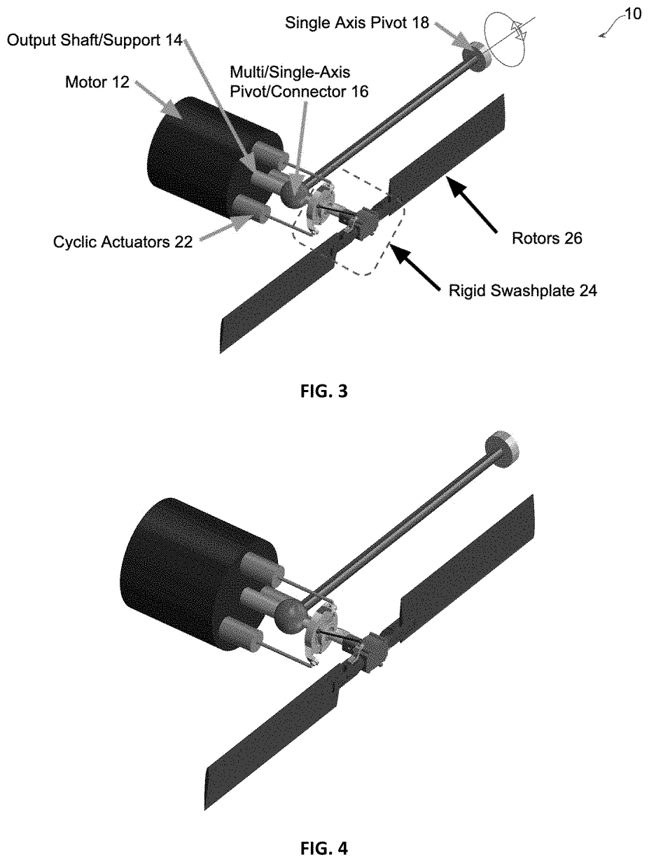

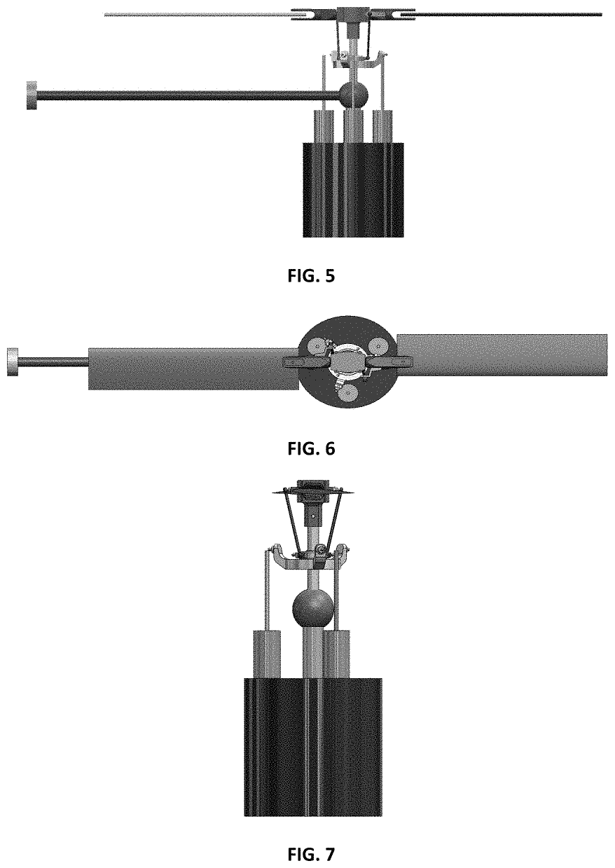

With reference to FIGS. 1-7, a propulsion system 10 is provided for use in a lighter-than-air aircraft 100 (e.g., airship, dirigible, and the like). However, it should be understood that the principles of the present teachings may find utility in a wide range of applications.

In some embodiments of the present teachings, propulsion system 10 can comprise a propulsion pod having a motor 12 driving an output shaft 14. The output shaft may also be enclosed within a support 14. The output shaft 14 can be coupled to a multi-axis pivot 16 that is coupled to a single-axis pivot 18 via a connecting rod 20. Multi-axis pivot 16 may be a two-axis gimbal joint. In another embodiment, the output shaft 14 can be coupled to a single-axis pivot 16 that is coupled to a single-axis pivot 18 via a connecting rod 20. In yet another embodiment, the output shaft 14 can be coupled to a fixed connection 16 that is coupled to a single-axis pivot 18 via a connecting rod 20. One or more cyclic actuators 22 can be operably coupled to a rigid swashplate 24 that is operably coupled to a plurality of rotors 26.

In this way, instead of rotating using a shaft, the swashplate can be used to rotate the propulsion pod. This arrangement, namely free-flapping, free pivoting, results in inertial loads not being imparted into shaft, whereas conventional system impart such loads due to their rigid or semi-rigid arrangement.

It is noted that for free-flapping, it may be necessary to provide continuous thrust/load.

Propulsion system 10 can be controlled relative to the LTA aircraft, via gravity-normal (with IMU), or other mechanical version. It should be recognized that joints can be one or more axis, such as but not limited to bearing joints, Heim joints, ball joints, U-joints, and the like.

In some embodiments, there can be single-axis rotation (vertical), however, horizontal rotation can be added.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A propulsion system for a lighter-than-air aircraft comprising:
a motor outputting a driving force;
one or more rotors; and
a free-pivoting, swashplate-controlled system interconnecting the motor and the one or more rotors.
